(19) United States
(12) Patent Application Publication
(10) Pub. No.: US 2026/0280017 A1
(43) Pub. Date: Sep. 17, 2026

(54) SYSTEM AND METHOD OF ARRANGING BATTERY CELLS INTO BATTERY MODULE AND BATTERY PACK

(71) Applicant: GM Global Technology Operations LLC, Detroit, MI (US)

(72) Inventors: Chinmaya Patil, South Lyon, MI (US); Xiaoling Chen, Sterling Heights, MI (US); Madhusudan Raghavan, West Bloomfield, MI (US); Norman K. Bucknor, Troy, MI (US); Neeraj S. Shidore, Novi, MI (US)

(73) Assignee: GM Global Technology Operations LLC, Detroit, MI (US)

(21) Appl. No.: 19/077,561

(22) Filed: Mar. 12, 2025

(51) Int. Cl. H01M 50/289; H01M 10/613; H01M 10/625; H01M 10/643; H01M 50/213; H01M 50/249; H01M 50/367

(52) U.S. Cl. CPC H01M 50/289; H01M 10/613; H01M 10/625; H01M 10/643; H01M 50/213; H01M 50/249; H01M 50/367; H01M 2220/20

(57) ABSTRACT

A vehicular battery assembly includes a casing, a first battery module, a second battery module, and a structural cross-member. The casing includes at least a first portion and a second portion. The first portion has a first height, and the second portion has a different second height. The first battery module is disposed at the first portion of the casing and includes a first plurality of cylindrical battery cells having longitudinal axes extending perpendicular to the first height and stacked relative to one another in a direction of the first height. The second battery module is disposed at the second portion of the casing and includes a second plurality of cylindrical battery cells having longitudinal axes extending perpendicular to the second height and stacked relative to one another in a direction of the second height. The structural cross-member is disposed between the first battery module and the second battery module.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure pertains to a rechargeable energy storage system (RESS), such as a battery pack, designed for use in vehicles. More specifically, the disclosure addresses the arrangement of battery cells and modules within the battery pack to meet packaging constraints and enhance the energy capacity of the battery pack.

Integrating a battery pack into a vehicle often presents various packaging challenges. For instance, positioning a battery pack near or at a vehicle's underbody is often desirable. However, the underbody may feature undulations or other shape variations, creating a non-uniform space for the battery pack. These variations are typically due to design considerations for the vehicle's interior compartment or seating area, aiming to fit the battery pack under the vehicle while minimizing interference and maximizing interior space. Despite this, battery packs are usually produced in uniform shapes, such as planar rectangular forms, which can lead to the battery pack being undersized to fit the vehicle's packaging constraints or necessitate structural modifications to the vehicle to accommodate the battery pack.

To maximize the energy capacity of the battery pack, it is crucial to efficiently arrange the battery cells and modules within the available space. This arrangement must ensure proper electrical connections for series and parallel configurations between the battery modules and cells. Additionally, other components within the battery pack, such as structural cross-members and venting channels, must be taken into account. The goal is to minimize empty space within the battery pack as much as possible. However, adapting the battery pack to fit non-uniform packaging constraints can be challenging, particularly with large format and block-shaped battery cells and modules. Therefore, it is essential to configure and arrange the battery modules and cells within non-uniform battery pack shapes in a way that maximizes energy capacity.

### SUMMARY

One aspect of the disclosure provides a vehicular battery assembly. The vehicular battery assembly includes a casing, a first battery module, a second battery module, and a structural cross-member. The casing includes at least a first portion and a second portion. The first portion has a first height, and the second portion has a second height different from the first height. The first battery module is disposed at the first portion of the casing and includes a first plurality of cylindrical battery cells having respective longitudinal axes extending perpendicular to the first height and stacked relative to one another in a direction of the first height. The second battery module is disposed at the second portion of the casing and includes a second plurality of cylindrical battery cells having respective longitudinal axes extending perpendicular to the second height and stacked relative to one another in a direction of the second height. The structural cross-member is disposed between the first battery module and the second battery module.

Implementations of this aspect of the disclosure may include one or more of the following optional features. In some examples, the first battery module includes a first row of cylindrical battery cells and a vent channel extending adjacent to first ends of the cylindrical battery cells. In some further examples, the first battery module includes a second row of cylindrical battery cells, and the vent channel extends between the first ends of the cylindrical battery cells at the first row and first ends of the cylindrical battery cells at the second row. In some other further examples, the vent channel is in fluid communication with a vent pathway at the structural cross-member. In some other further examples, a cooling element is disposed adjacent to second ends of the cylindrical battery cells at the first row. In some other further examples, a cooling element is disposed at a sidewall of the first battery module.

In some implementations, the vehicular battery assembly further includes an electrical busbar that electrically connects to the first battery module and the second battery module.

In some configurations, the first battery module and the second battery module are electrically connected to a propulsion system of a vehicle.

In some examples, the first height and the second height are configured to accommodate a packing boundary of the vehicular battery assembly at a vehicle.

In some implementations, a quantity of the first plurality of cylindrical battery cells is determined based on a maximum volume of the first battery module and a quantity of the second plurality of cylindrical battery cells is determined based on a maximum volume of the second battery module.

Another aspect of the disclosure provides a method. The method includes i) based on a packaging boundary for a casing of a vehicular battery assembly at a vehicle, determining a quantity of cylindrical battery cells that can be accommodated within the casing; ii) adjusting the quantity of cylindrical battery cells based on a parallel group count derived from dividing ampere hours of the vehicular battery assembly by ampere hours of one of the cylindrical battery cells; and iii) assigning individual ones of the adjusted quantity of cylindrical battery cells to a plurality of battery modules. The plurality of battery modules includes a first battery module and a second battery module. The first battery module is disposed at a first portion of the casing. The first portion of the casing has a first height. The first battery module includes a first plurality of cylindrical battery cells having respective longitudinal axes extending perpendicular to the first height and stacked relative to one another in a direction of the first height. The second battery module is disposed at a second portion of the casing. The second portion of the casing has a second height. The second battery module includes a second plurality of cylindrical battery cells having respective longitudinal axes extending perpendicular to the second height and stacked relative to one another in a direction of the second height. A structural cross-member is disposed between the first battery module and the second battery module.

Implementations of this aspect of the disclosure may include one or more of the following optional features. In some examples, the first battery module includes a first row of cylindrical battery cells and a vent channel extending adjacent to first ends of the cylindrical battery cells at the first row. In some further examples, the first battery module includes a second row of cylindrical battery cells, and the vent channel extends between the first ends of the first row of cylindrical battery cells at the first row and first ends of the cylindrical battery cells at the second row. In some other further examples, the vent channel is in fluid communication with a vent pathway at the structural cross-member.

In some implementations, the first plurality of cylindrical battery cells is assigned to the first battery module based on a maximum volume of the first battery module and the second plurality of cylindrical battery cells are assigned to the second battery module based on a maximum volume of the second battery module.

Yet another aspect of the disclosure provides a vehicle. The vehicle includes a vehicular battery assembly. The vehicular battery assembly includes a casing, a first battery module, a second battery module, and a structural cross-member. The casing includes at least a first portion and a second portion. The first portion has a first height, and the second portion has a second height different from the first height. The first battery module is disposed at the first portion of the casing and includes a first plurality of cylindrical battery cells having respective longitudinal axes extending perpendicular to the first height and stacked relative to one another in a direction of the first height. The second battery module is disposed at the second portion of the casing and includes a second plurality of cylindrical battery cells having respective longitudinal axes extending perpendicular to the second height and stacked relative to one another in a direction of the second height. The structural cross-member is disposed between the first battery module and the second battery module.

Implementations of this aspect of the disclosure may include one or more of the following optional features. In some examples, the first battery module includes a first row of cylindrical battery cells and a vent channel extending adjacent to first ends of the cylindrical battery cells at the first row. In some further examples, the first battery module includes a second row of cylindrical battery cells, and the vent channel extends between the first ends of the cylindrical battery cells at the first row and the first ends of the cylindrical battery cells at the second row.

In some implementations, the first height and the second height are configured to accommodate a packaging boundary of the vehicular battery assembly at the vehicle.

In some configurations, a quantity of the first plurality of cylindrical battery cells is determined based on a maximum volume of the first battery module and a quantity of the second plurality of cylindrical battery cells is determined based on a maximum volume of the second battery module.

### BRIEF DESCRIPTION OF THE DRAWINGS

The drawings described herein are for illustrative purposes only of selected configurations and are not intended to limit the scope of the present disclosure.

FIG. 1 is a perspective view of a vehicle including a vehicular battery assembly according to the present disclosure;

FIG. 2A is a perspective view of battery modules within the vehicular battery assembly of FIG. 1;

FIG. 2B is an exploded view of the battery module of FIG. 2A;

FIG. 3 is a side cross-sectional view of the battery module of FIG. 2A;

FIG. 4A is a top cross-sectional view of the battery module of FIG. 2A;

FIG. 4B is a top cross-sectional view of half of the battery module of FIG. 2A;

FIG. 5 is a top cross-sectional view of the vehicular battery assembly of FIG. 1;

FIG. 6A is a side cross-sectional view of the vehicular battery assembly of FIG. 1 in a first configuration;

FIG. 6B is a side cross-sectional view of the vehicular battery assembly of FIG. 1 in a second configuration; and

FIG. 7 is a flowchart of a method of packaging and assembling the vehicular battery assembly of FIG. 1.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

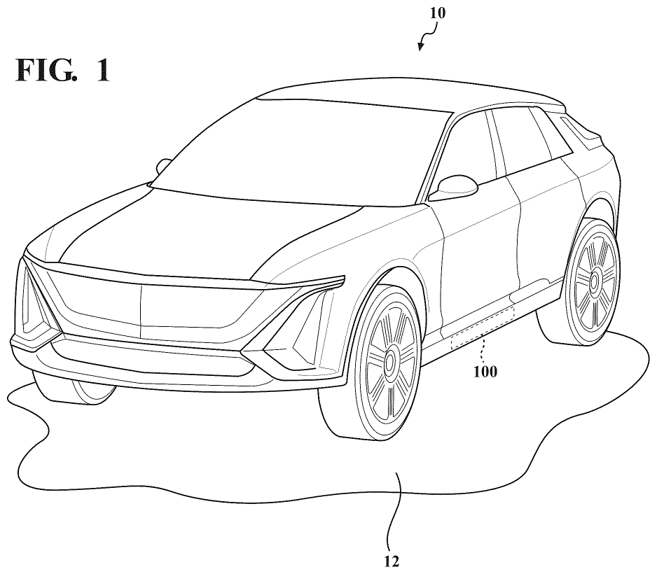

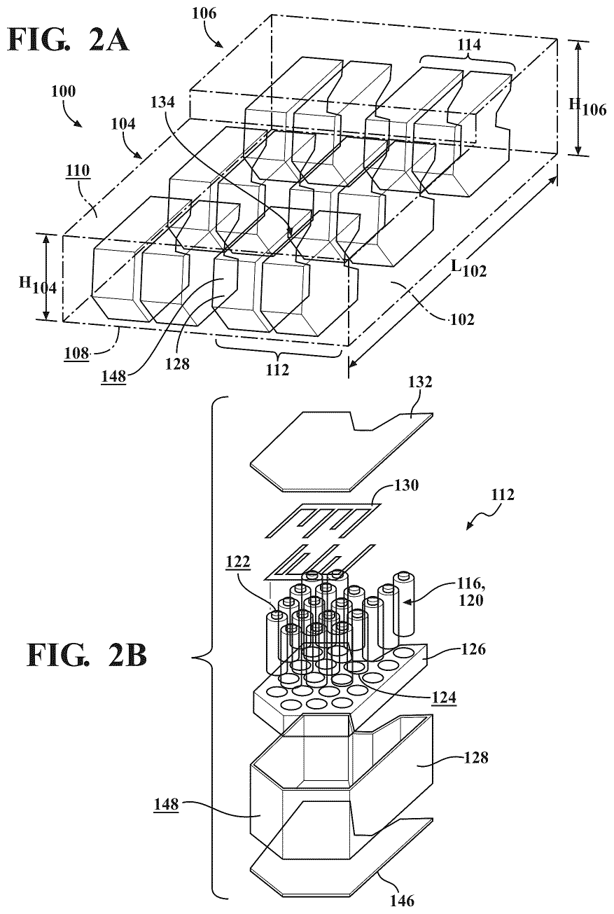

With reference to FIGS. 1-2B, a vehicle 10, such as an electric vehicle (EV) or plug-in hybrid vehicle (PHEV) or a hybrid vehicle, includes a rechargeable energy storage system (RESS) assembly or vehicular battery assembly 100 configured to store, recharge, and provide electrical power to components included at the vehicle 10. For example, the vehicular battery assembly 100 may include a lithium-ion battery assembly. The RESS assembly 100 may at least partially power a propulsion system of the vehicle 10. In this regard, when installed at the vehicle 10, energy stored at the RESS assembly 100 may enable the propulsion system to drive or power the vehicle 10.

The vehicular battery assembly 100 includes a casing or a housing or an enclosure 102 for mounting the RESS assembly 100 at the vehicle 10 and protecting electronic components of the RESS assembly 100. The casing 102 includes at least a first portion 104 and a second portion 106, which may be adjacent to the first portion 104. In this regard, the casing 102 may include other portions in addition to the first portion 104 and the second portion 106 without deviating from the context of this disclosure. The first portion 104 has a first height H₁₀₄ that extends between a bottom surface 108 of the casing 102 and a top surface 110 of the casing. Further, the second portion 106 has a second height H₁₀₆ that extends between the bottom surface 108 of the casing 102 and the top surface 110 of the casing. The first height H₁₀₄ and the second height H₁₀₆ differ from one another. In other words, height of the casing 102 varies along a length L₁₀₂ of the casing 102.

Differing heights H₁₀₄, H₁₀₆ of the first portion 104 and the second portion 106, respectfully, may be caused by undulations, ridges, bumps, cavities, or something of the like at the bottom surface 108, the top surface 110, or both the bottom surface 108 and the top surface 110. In this regard, portions of the bottom surface 108 that are adjacent to the first portion 104 may not be coplanar with portions of the bottom surface 108 that are adjacent to the second portion 106. In a similar manner, portions of the top surface 110 that are adjacent to the first portion 104 may not be coplanar with portions of the top surface 110 that are adjacent to the second portion 106. This allows the casing 102 to properly fit at a location of the vehicle 10 that may also include undulations, ridges, bumps, cavities, or something of the like, such as at an underbody of the vehicle 10. In other words, the casing 102 may be shaped to match or closely match a shape of a receptacle or receiving area or portion for the vehicular battery assembly 100 at the vehicle 10, such as to accommodate structural limitations at the vehicle 10. It should be appreciated that the casing 102 may vary in shape, such as based on the specific vehicle for which it is configured, without deviating from the context of this disclosure. That is, the length L₁₀₂, the first height H₁₀₄, the second height H₁₀₆, and other sizes, shapes and configurations of the casing 102 may be configured to accommodate a packaging boundary of the vehicular battery assembly 100 at the vehicle 10. The packaging boundary may be defined by structural components at the underbody of the vehicle 10 (e.g., components defining the interior cabin of the vehicle, the frame of the vehicle, and the like) and limits or reduces the available space and shape for mounting the vehicular battery assembly 100. With the battery assembly 100 installed at the vehicle 10, the first height H₁₀₄ and the second height H₁₀₆ of the casing 102 may extend in directions generally perpendicular to a ground surface 12, and the length L₁₀₂ of the casing 102 may extend in a direction generally parallel to the ground surface 12.

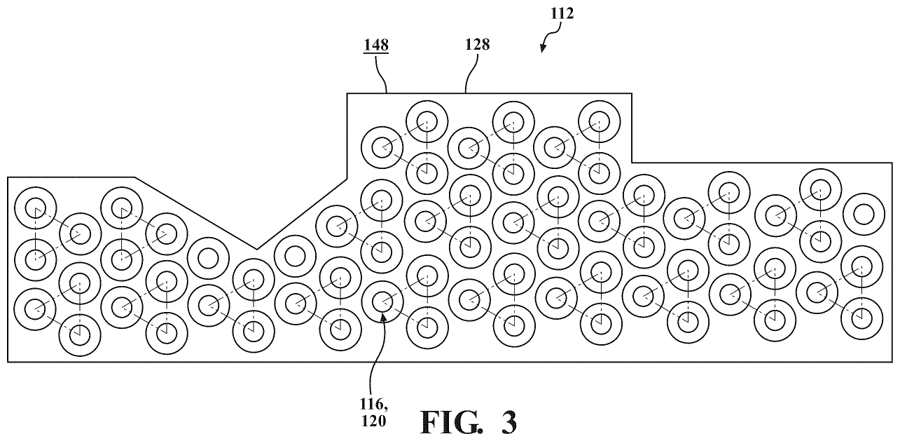

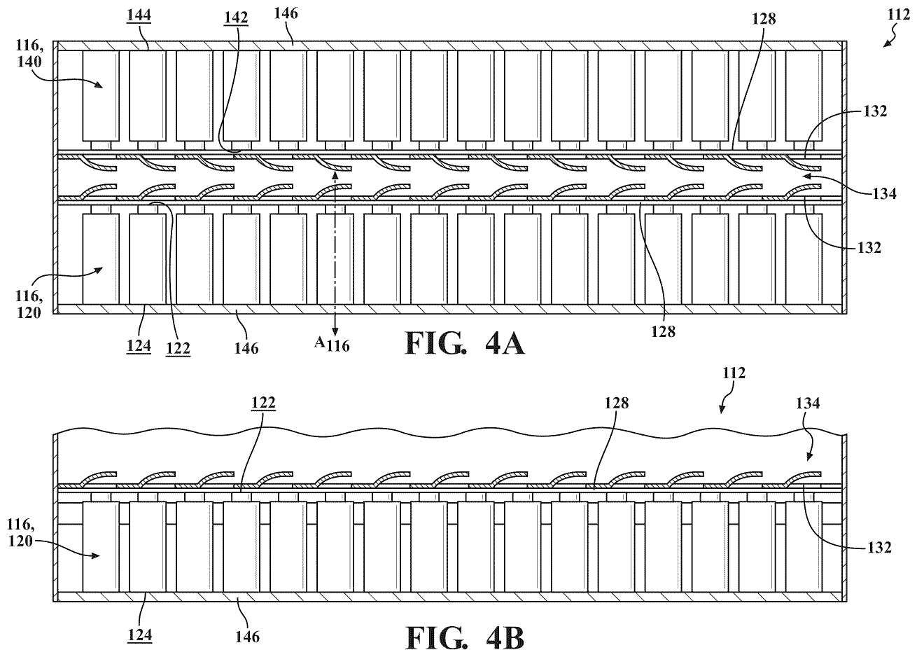

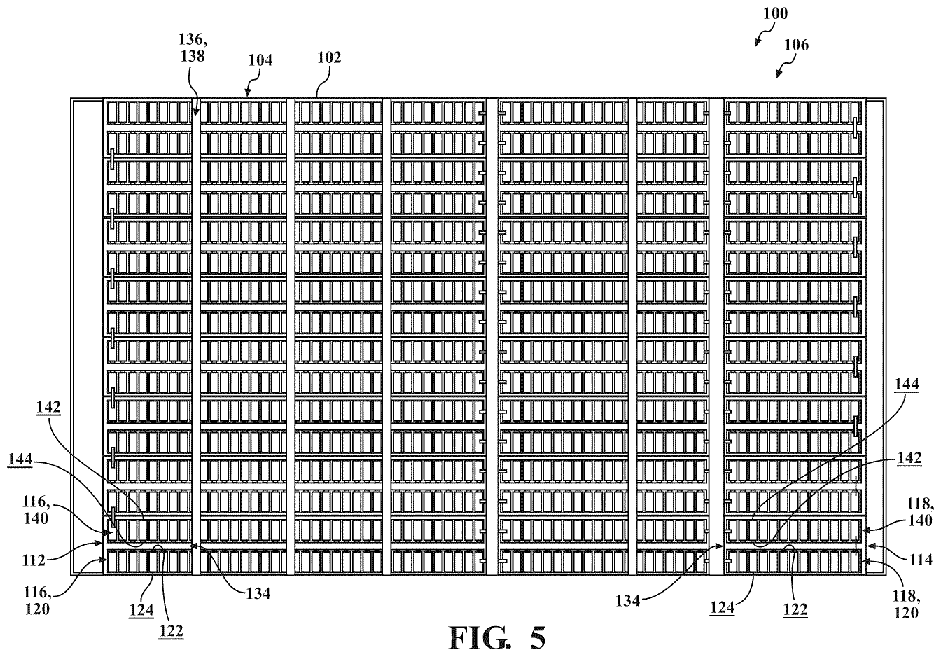

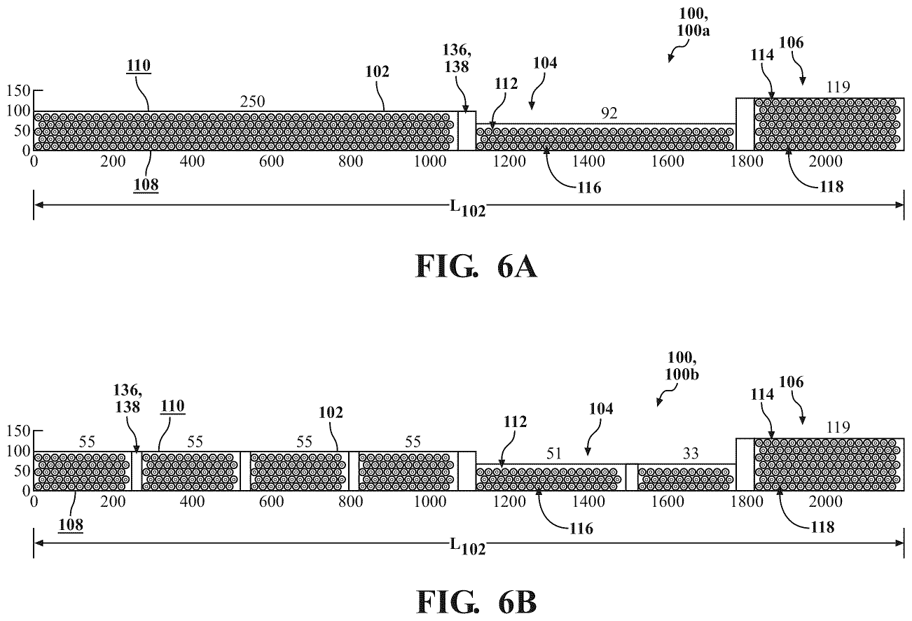

With continued reference to FIGS. 1-2B, and with reference to FIGS. 3-6B, the vehicular battery assembly 100 also includes a plurality of battery modules disposed within the casing 102. For example, the vehicular battery assembly 100 may include a first battery module 112 disposed at the first portion 104 of the casing 102 and a second battery module 114 disposed at the second portion 106 of the casing 102. It should be noted that the vehicular battery assembly 100 may include additional battery modules as accommodated by the specific size and shape of the casing 102. Furthermore, the battery modules 112, 114 may vary in size and shape between one another or may be sized and shaped identically to one another. The battery modules 112, 114 may also vary in size and shape across differently sized and shaped casings 102 due to the varying size and shape constraints of different vehicles at which the casings 102 may be installed.

The first battery module 112 and the second battery module 114 are configured to store energy and provide power to electrical components within the vehicle 10, such as a propulsion system of the vehicle 10. Power storage at the battery modules 112, 114 is facilitated by a plurality of cylindrical battery cells disposed at the battery modules 112, 114. For example, the first battery module 112 includes a first plurality 115 of cylindrical battery cells 116 extending perpendicular to the first height H₁₀₄ and stacked relative to one another in a direction of the first height H₁₀₄. In a similar manner, the second battery module 114 includes a second plurality 118 of cylindrical battery cells 116 extending perpendicular to the second height H₁₀₆ and stacked relative to one another in a direction of the first height H₁₀₆. In other words, the cylindrical battery cells 116 have respective longitudinal axes A₁₁₆ that extend in directions perpendicular to the first height H₁₀₄ and the second height H₁₀₆ of the casing 102. For example, and as shown in FIG. 3, the cylindrical battery cells 116 extend horizontally within the battery modules 112, 114 so that the cylindrical battery cells 116 may be stacked on top of one another to varying heights within the battery modules 112, 114. This allows each battery module 112, 114 to include one or more different height stacks of the cylindrical battery cells 116 and, thus, accommodate a variety of packaging constraints.

The following description will be made with respect to the first battery module 112 and the first plurality 115 of cylindrical battery cells 116. However, it should be appreciated that the second battery module 114 and the second plurality 118 of cylindrical battery cells 116 may be configured identically or similarly to the first battery module 112 and first plurality 115 of cylindrical battery cells 116, respectively. It should also be appreciated that the size and shape between the first battery module 112 and the second battery module 114 may vary between one another, as described above, while maintaining identical or similar configurations.

With continued reference to FIGS. 2A-6B, the first plurality 115 of cylindrical battery cells 116 at the first battery module 112 includes a first row 120 of cylindrical battery cells 116. The first row 120 of cylindrical battery cells 116 is arranged such that individual cylindrical battery cells 116 of the first row 120 are adjacent to one another in a direction parallel to the length L₁₀₂ of the casing 102. Further, the first row 120 of cylindrical battery cells 116 extends between first ends 122 of the cylindrical battery cells 116 and second ends 124 of the cylindrical battery cells 116. In other words, the cylindrical battery cells 116 in the first row 120 of cylindrical battery cells 116 have first ends 122 substantially in line with one another and second ends 124 substantially in line with one another. The first ends 122 may include positive terminals and the second ends 124 may include negative terminals of the cylindrical battery cells 116. Potting material 126 may be disposed at the first row 120 of cylindrical battery cells 116 and is configured to encapsulate, insulate, and protect the individual battery cells within the first row 120 of cylindrical battery cells 116. A cell holder 128 may surround the potting material 126 at the first row 120 of cylindrical battery cells 116 to provide rigidity and structure to the first battery module 112.

An electrical busbar 130 is disposed at the first ends 122 of the cylindrical battery cells 116. The electrical busbar 130 may include metallic strips or metallic bars and is configured to electrically connect the individual cylindrical battery cells 116 to the electrical systems of the vehicle 10. Further, the electrical busbar 130 may connect the battery modules included at the vehicular battery assembly 100 in series or parallel relative to one another and to the propulsion system of the vehicle 10. Also, a mica plate 132 may be included at the first battery module 112 such as adjacent to the electrical busbar 130 at the first row 120 of cylindrical battery cells 116. The mica plate 132 is configured to insulate the first battery module 112 and prevent thermal runaway.

The first battery module 112 may also include a vent channel 134 extending adjacent to the first ends 122 of the cylindrical battery cells 116. The vent channel 134 is configured to route gases that vent from the first plurality 115 of cylindrical battery cells 116 during operation of the vehicular battery assembly 100. Gases vented from the first plurality 115 of cylindrical battery cells 116 and routed through the vent channel 134 travel to a vent pathway 136 disposed at a structural cross-member 138 of the vehicular battery assembly 100, thus enabling gases to ultimately be routed outside of the casing 102. In other words, the vent channel 134 is in fluid communication with the vent pathway 136. The structural cross-member 138 is disposed within the casing 102 in a direction perpendicular to the length L₁₀₂ of the casing 102. The vehicular battery assembly 100 may include one or more structural cross-members in addition to the structural cross-member 138 depending on the shape and configuration of the casing 102. The structural cross-member 138 provides structural reinforcement to the casing 102, may separate modules within the casing 102 from one another, and may separate the first portion 104 and the second portion 106 from one another. For example, the vehicular battery assembly 100 in a first configuration 100a may include a lesser quantity of structural cross-members 138 compared to the vehicular battery assembly 100 in a second configuration 100b. The structural cross-members 138 may contribute to the packaging constraints of the vehicular battery assembly 100 and, thus, affect the number, size and/or shape of the battery modules.

The first plurality 115 of cylindrical battery cells 116 may also include a second row 140 of cylindrical battery cells 116. Space constraints within the casing 102 may require the first plurality 115 of cylindrical battery cells 116 to only include the first row 120 of cylindrical battery cells 116 or may accommodate the first plurality 115 of cylindrical battery cells 116 including the second row 140 of cylindrical battery cells 116 in addition to the first row 120 of cylindrical battery cells 116. The second row 140 of cylindrical battery cells 116 may be configured and arranged similarly or identically to the first row 120 of cylindrical battery cells 116. In this regard, the second row 140 of cylindrical battery cells 116 is arranged such that individual cylindrical battery cells 116 of the second row 140 are adjacent to one another in the direction parallel to the length L₁₀₂ of the casing 102. Further, the second row 140 of cylindrical battery cells 116 extends between the first ends 122 of the cylindrical battery cells 116 at the second row 140 and the second ends 124 of the cylindrical battery cells 116 at the second row 140. The first ends 122 of the cylindrical battery cells 116 at the second row 140 may face the first ends 122 of the cylindrical battery cells 116 at the first row 120. Potting material 126 may be disposed at the second row 140 of cylindrical battery cells 116 and is configured to encapsulate and protect the individual cylindrical battery cells 116 within the second row 140 of cylindrical battery cells 116. A cell holder 128 may surround the potting material 126 at the second row 140 of cylindrical battery cells 116 to provide rigidity and structure to the first battery module 112.

An electrical busbar 130 is disposed at the first ends 122 of the second row 140 of cylindrical battery cells 116. The electrical busbar 130 may include metallic strips or metallic bars and is configured to electrically connect the individual cylindrical battery cells 116 to the electrical systems of the vehicle 10. Also, a mica plate 132 may be included at the first battery module 112 such as adjacent to the electrical busbar 130 at the second row 140 of cylindrical battery cells 116. The mica plate 132 is configured to insulate the first battery module 112 and prevent thermal runaway. In this configuration, the vent channel 134 is disposed between respective first ends 122 of the first row 120 of cylindrical battery cells 116 and the second row 140 of cylindrical battery cells 116.

A cooling element 146 may also be included at the first battery module 112 and is configured to regulate temperature of the first battery module 112, thus regulating temperature of the vehicular battery assembly 100. The cooling element 146 may include a cooling plate that is disposed adjacent to the second ends 124 of the cylindrical battery cells 116 at the first row 120. Another cooling element 146 may also be disposed at or near the second ends 124 of the cylindrical battery cells 116 at the second row 140, such as if the first plurality 115 of cylindrical battery cells 116 includes the first row 120 of cylindrical battery cells 116 and the second row 140 of cylindrical battery cells 116. Alternatively, or additionally, a cooling ribbon 148 may be disposed at a sidewall 150 of the first battery module 112. The cooling ribbon 148 is configured to perform similarly to the cooling element 146.

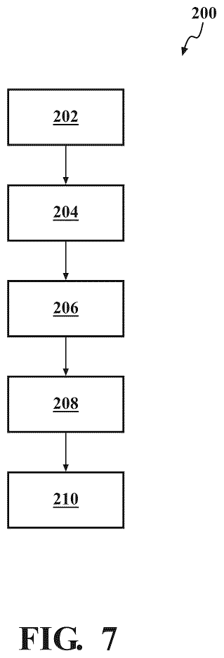

As stated above, the specific configuration and arrangement of the individual cylindrical battery cells 116 within the first and second rows 120, 140 of cylindrical battery cells 116, the specific configuration and arrangement of the first and second rows 120, 140 of cylindrical battery cells 116 within the first battery module 112, the specific configuration and arrangement of the first battery module 112, the second battery module 114, and all battery modules included within the casing 102, and the specific size and shape of the casing 102, may vary depending on the specific vehicle application for which the vehicular battery assembly 100 is configured, without deviating from the context of this disclosure. In this regard, FIG. 7 includes an example method 200 of packaging and arranging the first and second pluralities 115, 118 of cylindrical battery cells 116 within the first and second battery modules 112, 114, respectively. At operation 202, the method 200 includes determining a number or maximum quantity of cylindrical battery cells 116 that may be accommodated within the casing 102. The quantity may be determined based on the packaging boundary for the casing at the vehicle and/or other packaging constraints for the battery assembly. The maximum quantity of the first plurality 115 of cylindrical battery cells 116 may vary from the maximum quantity of the second plurality 118 of cylindrical battery cells 116 depending on the varying size between the first and second battery modules 112, 114. The varying size between the first and second battery modules 112, 114 may be dependent on the difference between the first height H₁₀₄ of the first portion 104 and the second height H₁₀₆ of the second portion 106. At operation 204, the method 200 includes adjusting the quantity of cylindrical battery cells 116 for the vehicular battery assembly based on a parallel group count derived from dividing ampere hours within the vehicular battery assembly 100 (e.g., a minimum value based on energy storage requirements for the vehicle) by ampere hours of an individual battery cell included at the first plurality 115 of cylindrical battery cells 116 or the second plurality 118 of cylindrical battery cells 116. The adjusted quantity of cylindrical battery cells accounts for amperage limitations or requirements of the vehicular battery assembly and may be equal to or lesser than the maximum quantity of the first and second pluralities 115, 118 of cylindrical battery cells 116.

At operation 206, the method 200 includes assigning individual ones of the adjusted quantity of cylindrical battery cells 116 among the first battery module 112, the second battery module 114, and all other battery modules included within the casing 102. This process maximizes common parts across the first and second battery modules 112, 114, as well as all battery modules included at the vehicular battery assembly 100. Further, this process also reduces the amount of empty or wasted space within the first and second battery modules 112, 114, as well as all battery modules included at the vehicular battery assembly 100. At 208, the ideal quantity of cylindrical battery cells are assembled into the plurality of battery modules included at the vehicular battery assembly 100. At operation 210, the method may include arranging the plurality of battery modules within the casing in a manner that reduces the amount of empty or wasted space within the casing 102.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicular battery assembly comprising:
a casing including at least a first portion and a second portion, the first portion having a first height, and the second portion having a second height different from the first height;
a first battery module disposed at the first portion of the casing, the first battery module including a first plurality of cylindrical battery cells having respective longitudinal axes extending perpendicular to the first height and stacked relative to one another in a direction of the first height;
a second battery module disposed at the second portion of the casing, the second battery module including a second plurality of cylindrical battery cells having respective longitudinal axes extending perpendicular to the second height and stacked relative to one another in a direction of the second height; and
a structural cross-member disposed between the first battery module and the second battery module.

2. The vehicular battery assembly of claim 1, wherein the first battery module includes a first row of cylindrical battery cells and a vent channel extending adjacent to first ends of the cylindrical battery cells.

3. The vehicular battery assembly of claim 2, wherein the first battery module includes a second row of cylindrical battery cells, the vent channel extending between the first ends of the cylindrical battery cells at the first row and first ends of the cylindrical battery cells at the second row.

4. The vehicular battery assembly of claim 2, wherein the vent channel is in fluid communication with a vent pathway at the structural cross-member.

5. The vehicular battery assembly of claim 2, wherein a cooling element is disposed adjacent to second ends of the cylindrical battery cells at the first row.

6. The vehicular battery assembly of claim 2, wherein a cooling element is disposed at a sidewall of the first battery module.

7. The vehicular battery assembly of claim 1, further comprising an electrical busbar that electrically connects to the first battery module and the second battery module.

8. The vehicular battery assembly of claim 1, wherein the first battery module and the second battery module are electrically connected to a propulsion system of a vehicle.

9. The vehicular battery assembly of claim 1, wherein the first height and the second height are configured to accommodate a packing boundary of the vehicular battery assembly at a vehicle.

10. The vehicular battery assembly of claim 1, wherein a quantity of the first plurality of cylindrical battery cells is determined based on a maximum volume of the first battery module and a quantity of the second plurality of cylindrical battery cells is determined based on a maximum volume of the second battery module.

11. A method comprising:
based on a packaging boundary for a casing of a vehicular battery assembly at a vehicle, determining a quantity of cylindrical battery cells that can be accommodated within the casing;
adjusting the quantity of cylindrical battery cells based on a parallel group count derived from dividing ampere hours of the vehicular battery assembly by ampere hours of one of the cylindrical battery cells; and
assigning individual ones of the adjusted quantity of cylindrical battery cells to a plurality of battery modules, the plurality of battery modules including:
a first battery module disposed at a first portion of the casing, the first portion of the casing having a first height, and the first battery module including a first plurality of cylindrical battery cells having respective longitudinal axes extending perpendicular to the first height and stacked relative to one another in a direction of the first height; and
a second battery module disposed at a second portion of the casing, the second portion of the casing having a second height, and the second battery module including a second plurality of cylindrical battery cells having respective longitudinal axes extending perpendicular to the second height and stacked relative to one another in a direction of the second height, and wherein a structural cross-member is disposed between the first battery module and the second battery module.

12. The method of claim 11, wherein the first battery module includes a first row of cylindrical battery cells and a vent channel extending adjacent to first ends of the cylindrical battery cells at the first row.

13. The method of claim 12, wherein the first battery module includes a second row of cylindrical battery cells, the vent channel extending between the first ends of the first row of cylindrical battery cells at the first row and first ends of the cylindrical battery cells at the second row.

14. The method of claim 12, wherein the vent channel is in fluid communication with a vent pathway at the structural cross-member.

15. The method of claim 11, wherein the first plurality of cylindrical battery cells is assigned to the first battery module based on a maximum volume of the first battery module and the second plurality of cylindrical battery cells are assigned to the second battery module based on a maximum volume of the second battery module.

16. A vehicle comprising:
a vehicular battery assembly including:
a casing including at least a first portion and a second portion, the first portion having a first height, and the second portion having a second height different from the first height;
a first battery module disposed at the first portion of the casing, the first battery module including a first plurality of cylindrical battery cells having respective longitudinal axes extending perpendicular to the first height and stacked relative to one another in a direction of the first height;
a second battery module disposed at the second portion of the casing, the second battery module including a second plurality of cylindrical battery cells having respective longitudinal axes extending perpendicular to the second height and stacked relative to one another in a direction of the second height; and
a structural cross-member disposed between the first battery module and the second battery module.

17. The vehicle of claim 16, wherein the first battery module includes a first row of cylindrical battery cells and a vent channel extending adjacent to first ends of the cylindrical battery cells at the first row.

18. The vehicle of claim 17, wherein the first battery module includes a second row of cylindrical battery cells, the vent channel extending between the first ends of the cylindrical battery cells at the first row and the first ends of the cylindrical battery cells at the second row.

19. The vehicle of claim 16, wherein the first height and the second height are configured to accommodate a packaging boundary of the vehicular battery assembly at the vehicle.

20. The vehicle of claim 16, wherein a quantity of the first plurality of cylindrical battery cells is determined based on a maximum volume of the first battery module and a quantity of the second plurality of cylindrical battery cells is determined based on a maximum volume of the second battery module.
